(19) United States
(12) Patent Application Publication
(10) Pub. No.: US 2022/0017998 A1
(43) Pub. Date: Jan. 20, 2022

(54) Method of fabrication of composite material based on vanadium alloy and steel

(71) Applicant: National University of Science and Technology MISIS, Moscow (RU)

(72) Inventors: Sergey Anatol'evich NIKULIN, Moscow (RU); Andrey Borisovich ROZHNOV, Moscow (RU); Stanislav Olegovich ROGACHEV, Moscow (RU); Vladislav Alekseevich BELOV, Moscow (RU); Tat'yana Anatol'evna NECHAYKINA, RP Oktyabr'skij (RU); Vladimir Markovich KHATKEVICH, Pereslavl'-Zalesskij (RU); Aleksandra Pavlovna BARANOVA, Sarov (RU)

(73) Assignee: National University of Science and Technology MISIS, Moscow (RU)

(21) Appl. No.: 17/312,211

(22) PCT Filed: Dec. 13, 2019
(86) PCT No.: PCT/RU19/50245

§ 371 Date: Jun. 9, 2021

(30) Foreign Application Priority Data
Dec. 13, 2018 (RU) 2018144226

(51) Int. Cl. C22C 27/02; C22F 1/18; C21D 9/00

(52) U.S. Cl. CPC C22C 27/025; C21D 9/0081; C22F 1/18

(57) ABSTRACT

The method of producing composite material with a high complex of mechanical properties, consisting of vanadium alloy inner layer V—3-11 wt % Ti—3-6 wt % Cr and two outer layers of stainless steel of ferritic grade with chromium content of not less than 13 wt %, includes preparation of a composite workpiece consisting of said inner layer and outer layers, hot treatment by pressure and subsequent exposure in furnace. Prepared composite workpiece, thickness of inner layer of which is 1.5-2 times more than total thickness of outer layers of stainless steel, hot working is performed with pressure of the workpiece in the temperature range of 1,050-1,150° C. with degree of reduction from 30 to 40% and with subsequent exposure for 1-3 hours with temperature reduction to 500-700° C., then annealing workpiece by heating to temperature of 850-950° C., holding for 2-4 hours and subsequent cooling in furnace.

### CROSS-REFERENCE TO RELATED APPLICATIONS

This application is a U.S. national stage application of an international application PCT/RU2019/050245 filed on 13 Dec. 2019, whose disclosure is incorporated herein in its entirety by reference, which international application claims priority of a Russian Federation patent application RU2018144226 filed on 13 Dec. 2018.

### FIELD OF THE INVENTION

This invention relates to industrial technologies of composite materials, more specifically, to deformation and heat treatment of composite materials on the basis of metals and alloys, and can be used for the fabrication of semi-finished products and products on their basis in the form of sheets, tapes, pipes and rods having a combination of superior mechanical, corrosion and radiation properties at high temperatures.

### BACKGROUND OF THE INVENTION

Known are methods of deformation and heat treatment of metals and alloys with the use of various pressure treatment technologies (forging, rolling, pressing etc.) and intermediate and final heat treatment (annealing, normalization etc.), Existing technologies provide for the required level of properties of semi-finished products and final products provided these are made from uniform materials but are not always applicable for semi-finished products and final products made from composite materials the components of which are substantially different in nature (for example, different metals and alloys on their basis) and have different physical and mechanical properties. In these cases, subject to the applicability of the same technologies and process equipment, it is at least required to choose special processing modes providing for uniform deformation of the material during plastic co-deformation and the required level of diffusion bonding between the components of the composite material coupled with the optimum set of physical and mechanical properties of the final composite material.

Known is a method of fabrication of a composite material by means of plastic co-deformation in which components of materials of different nature are placed in a bag (or in a composite mold), simultaneously exposed to deformation followed by heat treatment and are finally bonded to produce a whole composite material. The use of technologies of this type for the fabrication of critical parts for nuclear reactor core, e.g. nuclear reactor fuel rod cladding, from composite materials on the basis of different metals and alloys (steels etc.) was demonstrated e.g. in RU 2302044 “Fuel Rod of Fast Neutron Reactor with Lead Coolant”. A disadvantage of this method is potential deformation non-uniformity in components leading to different thicknesses of components being bonded and hence insufficient bonding force. Deformation non-uniformity in component layers depends on the ratio of strengths of the component metals, ratio of the thicknesses of the component layers, parameters of the deformation site, coefficient of external and interlayer friction and the mutual arrangement of the layers of the composite material billet. Deformation non-uniformity may cause tearing at component bonding interfaces.

Also known is a method of fabrication of composite materials on the basis of vanadium alloys and stainless steels in the form of sheets or pipes comprising the use of plastic co-deformation through combined hot rolling or pressing of the composite material billet at 1100° C. and annealing at temperatures in the 850° C. to 1000° C. range for two hours (S. A. Nikulin, S. N. Votinov, A. B. Rozhnov, Vanadium Alloys for Nuclear Power Industry, Moscow, MISiS, 2013, 184 p.). The fabrication of layered metallic composite materials in accordance with this method involves the formation of the so-called diffusion transition area characterizing the transfer of the components through the contact interface to both sides. The thickness of the diffusion transition area depends on the parameters of the fabrication process (deformation magnitude and rate, temperature) and parameters of the materials being bonded, but normally after the first fiteration of bonding the thickness of the diffusion transition area is within 5-10 μm. The diffusion transition area largely determines the bonding force of the composite material components and the possibility of further pressure treatment stages without defect formation. For the fabrication of a composite material from vanadium alloys and steel in accordance with the abovementioned method the thickness of the diffusion transition area forming during rolling (pressing) was within 8-10 μm while annealing at 1000° C. broadened the diffusion transition area by 60-80 μm. The thickness of the diffusion transition area in the case described provides for a certain degree of bonding between the components but is insufficient for providing a reliable and strong bond between the vanadium alloy and the steel; this is combined with a non-optimal grain structure of the components at the bonding interface and non-uniform diffusion transition area thickness in its length due to deformation non-uniformity in manufactured piece cross-section, and results in failure to provide for the required set of mechanical properties of the composite material in the manufactured piece. Thus the insufficient thickness of the diffusion transition area and the non-optimal microstructure at the component bonding interface are the disadvantages of the abovementioned method.

The closest related art of the invention disclosed herein which is selected as its prototype is the method described in S. A. Nikulin et al., Effect of Annealing on the Structure and Mechanical Properties of Three-Layered Steel/Vanadium Alloy/Steel Material, Non-Ferrous Metals, 2018, No. 2, p 70-75. In this method a composite material on the basis of vanadium alloy and steel was fabricated through plastic co-deformation (co-extrusion) at T=1100° C. followed by annealing at 800-900° C. for 2 h. This methods provides for relatively high strength and plasticity due to the formation of a somewhat thicker diffusion transition area of the bond (10-30 μm), absence of second phase precipitation at the composite material components bonding interface and the formation of moderately sized grains in the structure of the steel at the interface with the vanadium alloy (45-70 μm).

Disadvantages of the aforementioned method are that the thickness of the diffusion transition area between the vanadium alloy and steel is still insufficient (which may be especially expressed in areas where the layers have different thicknesses) and that the resultant structure is insufficiently uniform over the composite material cross-section which may lead to local exfoliation and the formation of discontinuities between the composite material layers at further pressure treatment stages. Moreover this method is highly power-consuming because it comprises reheating for subsequent annealing when the manufactured piece has completely cooled down after hot pressure treatment.

Therefore one object of this invention is to increase the thickness of the diffusion transition area of the bond between the components of the composite material (vanadium alloy and steel) and to avoid the precipitation of second phases at the bonding interface while maintaining an acceptable grain size of the vanadium alloy and steel in the vicinity of the interface (as well as structure uniformity over the composite material cross-section) so as to provide for the optimum set of mechanical properties of the material with respect to further composite material treatment stages. Yet another object of this invention is to reduce the power consumption of the method (at the stage of deformation and heat treatment).

The technical result of this invention is a high bonding strength (specimen exfoliation at deformation does not occur until specimen failure) between the components of the composite material (vanadium alloy and steel) combined with high plasticity (relative elongation 16-20%), absence of exfoliation at the component bonding interface at further treatment stages, and lower power consumption of the method.

### DESCRIPTION OF PREFERRED EMBODIMENTS OF THE INVENTION

The herein disclosed method of fabrication of composite material on the basis of vanadium alloy (the vanadium/titanium/chromium system) and stainless steel (chosen from ferrite steels) comprises hot pressure treatment of the composite material billet in a protective atmosphere at temperatures in the 1050-1150° C. range with a 30-40% reduction followed by tempering in the furnace which is implemented as a stepwise process, i.e., comprises cooling from the hot treatment temperature to 500-700° C., tempering for 1-3 h, heating to 850-850° C., tempering for 2-4 h and cooling in the furnace so the overall time of tempering in the furnace reaches 3-7 h.

The method disclosed herein provides for the formation of a diffusion bonding area between the vanadium alloy and steel with a large thickness of 60-70 μm with an insignificant increase in the grain size of the vanadium alloy and steel, reduction of residual stresses and absence of second phase precipitation, which for the preset ratio of layer thicknesses in the composite material billet provides for an improved set of mechanical properties of the composite material.

An important aspect of the method disclosed herein is that the increase in the overall heat treatment (annealing) time delivers an increase in the thickness of the diffusion transition area of the bond, a more uniform structure and a reduction of residual stresses over the material cross-section due to recrystallization processes, while avoiding the expected significant increase in the grain size of the composite material components and second phase precipitation at the bonding interface (due to the implementation of a stepwise tempering sequence) and hence delivering an improved set of mechanical properties of the material. Furthermore the method disclosed herein provides for lower power consumption due to the phasing out of additional reheating before annealing.

Increasing the time of tempering after heat treatment to several hours is acceptable in the practice of heat treatment unless it causes undesirable consequences such as the formation of brittle compounds at the bonding interface or an abrupt growth of grain size in the components of the composite material. The use of slightly lower tempering temperatures (500-700° C.) somewhat decelerates structural evolution processes in the composite material but develops auspicious conditions for diffusion processes which increase the thickness of the diffusion transition area between the components and increases the strength of the bond.

The method disclosed herein is implemented as follows. The composite material billet is prepared using known conventional methods in the form of a sheet, a tape, a pipe or a rod comprising an inner layer of vanadium alloy (V-3-11 wt. %Ti-3-6 wt. %Cr) and two outer layers of stainless steel (chosen from ferritic steels with a chromium content of at least 13 wt. %). The thickness of the vanadium alloy layer in this composite material billet is 1.5-2.0 times greater than the total thickness of the steel layers. The composite material billet is hot pressed or hot rolled in a protective atmosphere at a temperature in the 1050-1150° C. range with a reduction of 30-40%. Then the pressed billet is cooled down to a temperature in the 500-700° C. range during 1-3 h in the protective atmosphere, then heated to 850-950° C., tempered (annealed) for 2-4 h in the protective atmosphere and finally cooled in the furnace.

To implement one of the embodiments of the method disclosed herein the instant inventors used by way of example a three-layered sheet billet of V-4%Ti-4%Cr alloy with a thickness of 1850 pm located between two layers of 08Cr17Ti stainless steel which were located under the bottom and on the top of the vanadium alloy layer and had a total thickness of 300 μm. The three-layered billet was prepared in a conventional way including surface machining and vacuum treatment. The composite material billet was hot rolled in a protective atmosphere at 1100° C. The thickness of the as-hot rolled three-layered billet was 1750 μm. After hot rolling the three-layered billet was cooled down to 600° C. for 2 h in the protective atmosphere. Then the billet was transferred to the furnace and annealed at 900° C. for 3 h in the protective atmosphere of argon gas and cooled down in the furnace.

After the treatment, the billet was cut into specimens in different areas of billet length for materials science study (analysis of microstructure and chemical element redistribution in the bonding area). The results of analysis showed that the thickness of the diffusion transition area of the bond was 70±5 μm, no second phase precipitation occurred at the bonding interface layer and the steel grain size in the vicinity of the bonding interface was 65±5 μm. The bonding interface did not contain any defects (cracks, exfoliation etc.). Tensile tests of the bimetallic microscopic specimens cut perpendicular to the pipe walls showed a good set of mechanical properties (σ_{0.2}310±12 MPa, σ_{B}=450±15 MPa and δ=20±2%) and their better reproducibility over the pipe length (the mechanical parameters were reproducible accurate to ±5-7% along the pipe). Thus the tests showed that the use of the method disclosed herein allows achieving a significant increase in the thickness of the diffusion transition area without second phase precipitation or significant grain size growth of composite material components at the bonding interface. This provides for an improved set of mechanical properties of the composite material and stable mechanical properties in the pipe length.

What is claimed is a:

1. Method of fabricating a composite material comprising an inner layer of V-3-11 wt. %Ti-3-6 wt. %Cr vanadium alloy and two outer layers of stainless ferritic steel containing at least 13 wt. % chromium, said method comprising preparation of a composite material billet comprising said inner layer and two outer layers and hot pressure treatment followed by tempering in the furnace wherein said composite material billet is prepared such that the thickness of said inner layer is 1.5-2 times greater than the total thickness of said two outer layers of stainless steel, said composite material billet is hot pressure treated in the 1050-1150° C. range with a reduction of 30-40% followed by tempering for 1-3 h during temperature reduction to 500-700° C., annealed by heating to 850-950° C., tempered for 2-4 h and cooled in the furnace.

2. Method of claim 1 wherein said hot pressure treatment is hot pressing or hot rolling.

3. Method of claim 1 wherein said hot pressure treatment and tempering are effected in a protective atmosphere.
